(19) United States
(12) Patent Application Publication
(10) Pub. No.: US 2024/0078850 A1
(43) Pub. Date: Mar. 7, 2024

(54) MANAGEMENT DEVICE AND MANAGEMENT METHOD

(71) Applicant: TOYOTA JIDOSHA KABUSHIKI KAISHA, Toyota-shi (JP)

(72) Inventor: Hirofumi MOMOSE, Numazu-shi (JP)

(73) Assignee: TOYOTA JIDOSHA KABUSHIKI KAISHA, Toyota-shi (JP)

(21) Appl. No.: 18/347,738

(22) Filed: Jul. 6, 2023

(30) Foreign Application Priority Data
Sep. 5, 2022 (JP) 2022-140822

(51) Int. Cl. G07C 5/00; G05D 1/00

(52) U.S. Cl. CPC G07C 5/008; G05D 1/0027; G05D 2201/0213

(57) ABSTRACT

A management device manages a remote operation of a moving body. The management device collects abnormality report information indicating a content of an abnormality related to the remote operation of the moving body from a remote operator assigned to the moving body. Based on the abnormality report information collected from a plurality of remote operators, the management device determines whether there is an abnormality in any of a plurality of moving bodies and whether there is an abnormality in any of a plurality of remote operator terminals respectively operated by the plurality of remote operators.

### CROSS-REFERENCE TO RELATED APPLICATION

This application claims priority to Japanese Patent Application No. 2022-140822, filed on Sep. 5, 2022, the entire contents of which are incorporated by reference herein.

### BACKGROUND

### Technical Field

The present disclosure relates to a technique for managing a remote operation of a moving body performed by a remote operator.

### Background Art

Patent Literature 1 discloses a driving control device that detects an abnormality of a remote operator. The driving control device includes: a travel information acquisition unit that acquires travel information of a vehicle that can be remotely driven by a driving operation performed by the remote operator; and a driving determination unit that uses the travel information to determine whether or not the driving operation is appropriate.

### List of Related Art

Patent Literature 1: Japanese Laid-Open Patent Application No. JP-2021-60764

### SUMMARY

A remote operation (remote driving, remote control, remote support) of a moving body is considered. A remote operator remotely operates the moving body by operating a remote operator terminal. When there is an abnormality in the remote operator terminal or the moving body being a target of the remote operation, accuracy of the remote operation decreases. Therefore, it is desirable to identify an abnormal part related to the remote operation.

An object of the present disclosure is to provide a technique capable of identifying an abnormal part related to a remote operation of a moving body performed by a remote operator.

A first aspect is directed to a management device for managing a remote operation of a moving body.

The management device includes one or more processors.

The one or more processors are configured to:
collect abnormality report information indicating a content of an abnormality related to the remote operation of the moving body from a remote operator assigned to the moving body; and
determine, based on the abnormality report information collected from a plurality of remote operators, whether there is an abnormality in any of a plurality of moving bodies and whether there is an abnormality in any of a plurality of remote operator terminals respectively operated by the plurality of remote operators.

A second aspect is directed a management method for managing a remote operation of a moving body by a computer.
the management method includes:
collecting abnormality report information indicating a content of an abnormality related to the remote operation of the moving body from a remote operator assigned to the moving body; and
determining, based on the abnormality report information collected from a plurality of remote operators, whether there is an abnormality in any of a plurality of moving bodies and whether there is an abnormality in any of a plurality of remote operator terminals respectively operated by the plurality of remote operators.

According to the present disclosure, it is possible to identify an abnormal part related to the remote operation of the moving body performed by the remote operator.

### BRIEF DESCRIPTION OF DRAWINGS

FIG. 1 is a schematic diagram showing a configuration example of a remote operation system according to an embodiment;

FIG. 2 is a conceptual diagram for explaining an overview of an abnormality management process according to an embodiment;

FIG. 3 is a conceptual diagram showing an example of abnormality report information according to an embodiment;

FIG. 4 is a block diagram showing a configuration example of a vehicle according to an embodiment;

FIG. 5 is a block diagram showing a configuration example of a remote operator terminal according to an embodiment; and

FIG. 6 is a block diagram showing a configuration example of a management device according to an embodiment;

### EMBODIMENTS

Embodiments of the present disclosure will be described with reference to the accompanying drawings.

### 1. Overview of Remote Operation System

A remote operation of a moving body is considered. The remote operation is a concept that includes remote driving, remote control, and remote support. Examples of the moving body include a vehicle, a robot, and the like. The vehicle may be an autonomous driving vehicle or may be a vehicle driven by a driver. Examples of the robot include a logistics robot, a work robot, and the like. As an example, in the following description, a case where the moving body being the target of the remote operation is a vehicle will be considered. When generalizing, “vehicle” in the following description shall be deemed to be replaced with “moving body.”

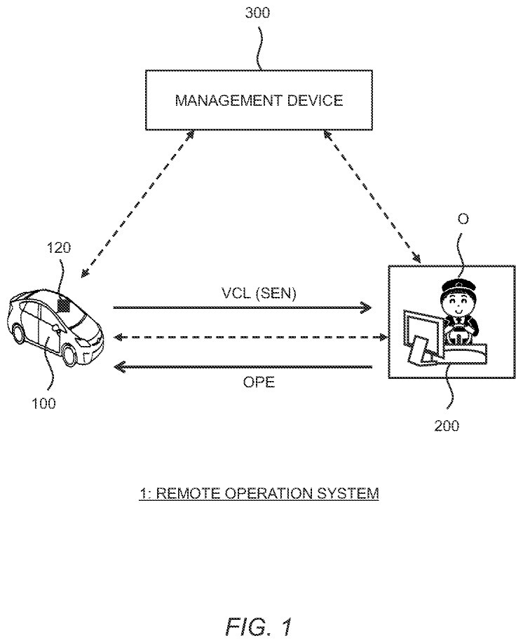

FIG. 1 is a schematic diagram showing a configuration example of a remote operation system 1 according to the present embodiment. The remote operation system 1 includes a vehicle 100, a remote operator terminal 200, and a management device 300. The vehicle 100 is the target of the remote operation. The remote operator terminal 200 is a terminal device used by a remote operator O when remotely operating the vehicle 100. The remote operator terminal 200 can also be referred to as a remote cockpit. The management device 300 manages the remote operation system 1. Typically, the management device 300 is a management server on a cloud. The management server may be configured by a plurality of servers that perform distributed processing.

The vehicle 100, the remote operator terminal 200, and the management device 300 are capable of communicating with each other via a communication network. The vehicle 100 and the remote operator terminal 200 can communicate with each other via the management device 300. The vehicle 100 and the remote operator terminal 200 may directly communicate with each other without through the management device 300.

Various sensors 120 are installed on the vehicle 100. For example, the sensor 120 includes a camera that images a situation around the vehicle 100. As another example, the sensor 120 may include a microphone that detects sound around the vehicle 100. Sensor-detected information SEN is information detected by the sensor 120 mounted on the vehicle 100. The sensor-detected information SEN includes at least an image captured by the camera. The vehicle 100 transmits vehicle information VCL including at least a part of the sensor-detected information SEN to the remote operator terminal 200.

The remote operator terminal 200 receives the vehicle information VCL transmitted from the vehicle 100. The remote operator terminal 200 presents the sensor-detected information SEN to the remote operator O through an output device. For example, the remote operator terminal 200 includes a display device and displays the image captured by the camera of the vehicle 100 on the display device. As another example, the remote operator terminal 200 includes a speaker and outputs the sound detected by the microphone of the vehicle 100 from the speaker. The remote operator O recognizes the situation around the vehicle 100 by referring to the presented sensor-detected information SEN. Then, the remote operator O performs the remote operation of the vehicle 100 by operating a remote operation member provided in the remote operator terminal 200. Remote operation information OPE is information relating to the remote operation performed by the remote operator O. For example, the remote operation information OPE includes an amount of operation of the remote operation member by the remote operator O. The remote operator terminal 200 transmits the remote operation information OPE to the vehicle 100.

The vehicle 100 receives the remote operation information OPE transmitted from the remote operator terminal 200. The vehicle 100 performs vehicle travel control in accordance with the received remote operation information OPE. In this manner, the remote operation of the vehicle 100 is realized.

The management device 300 manages the remote operation of the vehicle 100 performed by the remote operator O. In other words, the management device 300 manages a remote operation service in which the remote operator O remotely operates the vehicle 100. More specifically, the vehicle 100 (a target vehicle) requiring the remote operation transmits a remote operation request to the management device 300. In response to the remote operation request, the management device 300 selects an available remote operator O from among a plurality of remote operators O and assigns the selected remote operator O to the target vehicle 100. The management device 300 notifies the target vehicle 100 and the remote operator terminal 200 operated by the assigned remote operator O of the assignment result. The target vehicle 100 and the remote operator terminal 200 start communicating with each other. The remote operator O assigned to the target vehicle 100 operates the own remote operator terminal 200 to remotely operate the target vehicle 100.

### 2. Abnormality Management Process

When there is an abnormality in the remote operator terminal 200 or the vehicle 100 being the target of the remote operation, accuracy of the remote operation decreases. The management device 300 according to the present embodiment has a function of performing an “abnormality management process” for managing such the abnormality related to the remote operation. For example, the abnormality management process includes identifying an abnormal part related to the remote operation. As another example, the abnormality management process may include excluding the vehicle 100 or the remote operator terminal 200 having the abnormality from an operation of the remote operation service. Hereinafter, the abnormality management process according to the present embodiment will be further described.

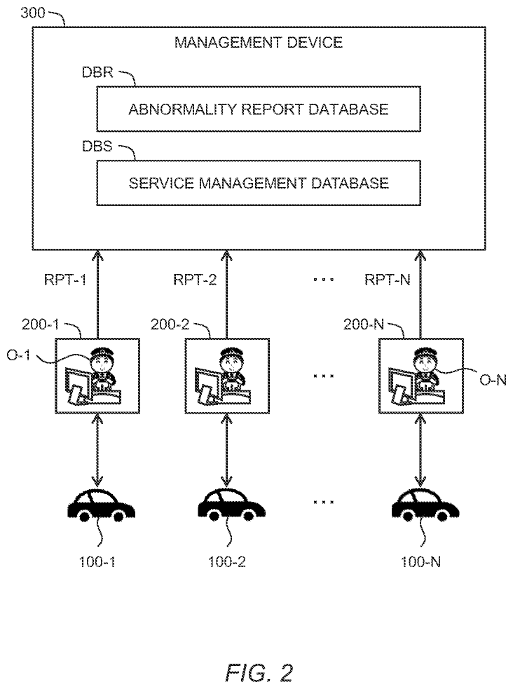

FIG. 2 is a conceptual diagram for explaining an overview of the abnormality management process. Here, a plurality of vehicles 100-1 to 100-N, a plurality of remote operators O-1 to O-N, and a plurality of remote operator terminals 200-1 to 200-N are considered. N is an integer equal to or greater than 2. The remote operator O-i is assigned to the vehicle 100-i being the target of the remote operation (i=1 to N). The remote operator O-i remotely operates the vehicle 100-i by operating the remote operator terminal 200-i.

It should be noted that the assignment relationship between the remote operator O-i and the vehicle 100-i dynamically changes. For example, a remote operator O-1 may remotely operate a vehicle 100-1 and then remotely operate another vehicle 100-2. As another example, a vehicle 100-1 may be remotely operated by a remote operator O-1 during a certain period of time and remotely operated by another remote operator O-3 during another period of time.

During the remote operation of the vehicle 100-i, the remote operator O-i may notice an abnormality related to the remote operation. There are various examples of the abnormality related to the remote operation that the remote operator O-i notices. Some examples of the abnormality related to the remote operation that the remote operator O-i notices are as follows.

[a] An abnormality of the output device (e.g., the display device, the speaker) of the remote operator terminal 200-i; for example, the image is dark, a quality of the image is low, the sound is hard to hear, and so forth.

[b] An abnormality of the remote operation member (e.g., a steering wheel) of the remote operator terminal 200-i; for example, the steering wheel is heavy, and so forth.

[c] An abnormality of the sensor-detected information SEN (e.g., the image, the sound); for example, the image is interrupted, the image is dark, the quality of the image is low, the camera is out of focus, an angle of view of the camera is misaligned, the sound is hard to hear, and so forth.

[d] An abnormality of the vehicle state of the vehicle 100; for example, there is a possibility that vehicle 100 is punctured, and so forth.

The remote operator O-i inputs a content of the abnormality noticed during the remote operation of the vehicle 100-i by using an input device provided in the remote operator terminal 200-i. The remote operator terminal 200-i generates “abnormality report information RPT-i” based on the input from the remote operator O-i.

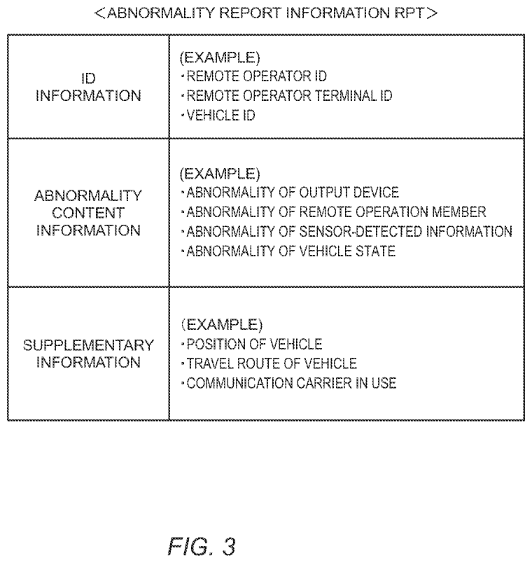

FIG. 3 is a conceptual diagram showing an example of the abnormality report information RPT-i. The abnormality report information RPT-i includes abnormality content information. The abnormality content information indicates the content of the abnormality related to the remote operation of the vehicle 100-i noticed by the remote operator O-i (e.g., at least one of [a] to [d] described above).

The abnormality report information RPT-i may include identification information. Examples of the identification information include identification information of the vehicle 100-i, identification information of the remote operator terminal 200-i, and identification information of the remote operator O-i.

The abnormality report information RPT-i may include supplementary information. For example, the supplementary information includes position information of the vehicle 100-i. The supplementary information may include a travel route of the vehicle 100-i. The supplementary information may include information of a communication carrier used for the communication between the vehicle 100-i and the remote operator terminal 200-i.

The remote operator terminal 200-i transmits the abnormality report information RPT-i to the management device 300. The abnormality report information RPT-i may be transmitted during execution of the remote operation of the vehicle 100-i or may be transmitted after an end of the remote operation of the vehicle 100-i. The abnormality report information RPT-i may be directly transmitted from the remote operator terminal 200-i to the management device 300, or may be transmitted to the management device 300 via the vehicle 100-i.

The management device 300 collects the abnormality report information RPT-1 to RPT-N respectively transmitted from the plurality of remote operator terminals 200-1 to 200-N. In other words, the management device 300 collects the abnormality report information RPT-1 to RPT-N respectively from the plurality of remote operators O-1 to O-N. The management device 300 registers the collected abnormality report information RPT-1 to RPT-N on an “abnormality report database DBR.”

The management device 300 identifies an abnormal part related to the remote operation based on the abnormality report database DBR. That is, the management device 300 determines, based on the abnormality report database DBR, whether there is an abnormality in any of the plurality of vehicle 100-1 to 100-N and whether there is an abnormality in any of the plurality of remote operator terminals 200-1 to 200-N.

As an example, a case where there are more than a certain number of abnormality report information RPT indicating the abnormality related to a specific vehicle 100-X is considered. The abnormality related to a specific vehicle 100-X includes at least one of the abnormality of the sensor-detected information SEN transmitted from the specific vehicle 100-X and the abnormality of the vehicle state of the specific vehicle 100-X. When the number of the abnormality report information RPT indicating the abnormality related to a specific vehicle 100-X is equal to or greater than a first threshold, the management device 300 determines that there is the abnormality in the specific vehicle 100-X. In particular, the management device 300 determines that there is the abnormality in a part related to the content of the abnormality indicated by the abnormality report information RPT among parts of the specific vehicle 100-X.

As another example, a case where there are more than a certain number of abnormality report information RPT indicating the abnormality related to a specific remote operator terminal 200-X is considered. The abnormality related to a specific remote operator terminal 200-X includes at least one of the abnormality of the output device of the specific remote operator terminal 200-X, the abnormality of the remote operation member of the specific remote operator terminal 200-X, and the abnormality of the sensor-detected information SEN output from the output device of the specific remote operator terminal 200-X. When the number of the abnormality report information RPT indicating the abnormality related to a specific remote operator terminal 200-X is equal to or greater than a second threshold, the management device 300 determines that there is the abnormality in the specific remote operator terminal 200-X. In particular, the management device 300 determines that there is the abnormality in a part related to the content of the abnormality indicated by the abnormality report information RPT among parts of the specific remote operator terminal 200-X.

As still another example, when an increase rate of the number of the abnormality report information RPT indicating the abnormality related to a specific vehicle 100-X is equal to or greater than a third threshold, the management device 300 may determine that the is the abnormality in the specific vehicle 100-X. Similarly, when an increase rate of the number of the abnormality report information RPT indicating the abnormality related to a specific remote operator terminal 200-X is equal to or greater than a fourth threshold, the management device 300 may determine that there is the abnormality in the specific remote operator terminal 200-X.

As still another example, when the number of the abnormality report information RPT indicating the abnormality related to the vehicle 100-i present in a specific place is equal to or greater than a fifth threshold, the management device 300 may determine that there is an abnormality in the specific place. As another example, when an increase rate of the number of the abnormality report information RPT indicating the abnormality related to the vehicle 100-i present in a specific place is equal to or greater than a sixth threshold, the management device 300 may determine that there is an abnormality in the specific place.

As still another example, when the number of the abnormality report information RPT indicating the abnormality of the sensor-detected information SEN when a specific communication carrier is used is equal to or greater than a seventh threshold, the management device 300 may determine that there is an abnormality in the specific communication carrier. As another example, when an increase rate of the number of the abnormality report information RPT indicating the abnormality of the sensor-detected information SEN when a specific communication carrier is used is equal to or greater than an eighth threshold, the management device 300 may determine that there is an abnormality in the specific communication carrier.

The management device 300 holds a service management database DBS for managing an operation of the remote operation service. The management device 300 updates the service management database DBS according to a result of the abnormality determination process described above. For example, the management device 300 excludes the vehicle 100 or the remote operator terminal 200 having the abnormality from the operation of the remote operation service. As another example, the management device 300 may suspend the operation of the remote operation service in the place where the abnormality occurs. As still another example, the management device 300 may suspend the use of the communication carrier having the abnormality.

The management device 300 may automatically arrange repair of the vehicle 100 or the remote operator terminal 200 having the abnormality.

<Effects>

As described above, according to the present embodiment, the abnormality report information RPT indicating the content of the abnormality related to the remote operation of the vehicle 100 is collected from the remote operator O assigned to the vehicle 100. Then, based on the abnormality report information RPT collected from the plurality of remote operators O, whether there is an abnormality in any of the plurality of vehicles 100 and whether there is an abnormality in any of the plurality of remote operator terminals 200 are determined. As a result, it is possible to efficiently identify the abnormal part related to the remote operation of the vehicle 100 performed by the remote operator O.

Furthermore, excluding the vehicle 100 or the remote operator terminal 200 having the abnormality from the operation of the remote operation service makes it possible to ensure safety of the remote operation service.

Hereinafter, concrete examples of the vehicle 100, the remote operator terminal 200, and the management device 300 will be described.

### 3. Example of Vehicle

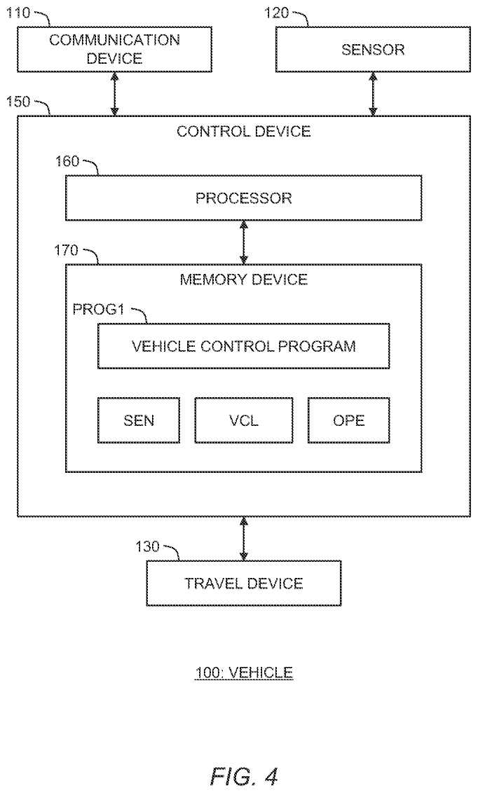

FIG. 4 is a block diagram showing a configuration example of the vehicle 100. The vehicle 100 includes a communication device 110, a sensor 120, a travel device 130, and a control device (controller) 150.

The communication device 110 communicates with the outside of the vehicle 100. For example, the communication device 110 communicates with the remote operator terminal 200 and the management device 300.

The sensor 120 includes a recognition sensor, a vehicle state sensor, a position sensor, and the like. The recognition sensor recognizes (detects) a situation around the vehicle 100. Examples of the recognition sensor include a camera, a LIDAR (Laser Imaging Detection and Ranging), a radar, a microphone, and the like. The vehicle state sensor detects a state of the vehicle 100. Examples of the vehicle state sensor include a speed sensor, an acceleration sensor, a yaw rate sensor, a steering angle sensor, and the like. The position sensor detects a position and an orientation of the vehicle 100. For example, the position sensor includes a GNSS (Global Navigation Satellite System).

The travel device 130 includes a steering device, a driving device, and a braking device. The steering device turns wheels. For example, the steering device includes an electric power steering (EPS) device. The driving device is a power source that generates a driving force. Examples of the drive device include an engine, an electric motor, an in-wheel motor, and the like. The braking device generates a braking force.

The control device 150 is a computer that controls the vehicle 100. The control device 150 includes one or more processors 160 (hereinafter simply referred to as a processor 160) and one or more memory devices 170 (hereinafter simply referred to as a memory device 170). The processor 160 executes a variety of processing. For example, the processor 160 includes a CPU (Central Processing Unit). The memory device 170 stores a variety of information necessary for the processing by the processor 160. Examples of the memory device 170 include a volatile memory, a non-volatile memory, an HDD (Hard Disk Drive), an SSD (Solid State Drive), and the like. The control device 150 may include one or more ECUs (Electronic Control Units).

A vehicle control program PROG1 is a computer program executed by the processor 160. The functions of the control device 150 are implemented by the processor 160 executing the vehicle control program PROG1. The vehicle control program PROG1 is stored in the memory device 170. The vehicle control program PROG1 may be recorded on a non-transitory computer-readable recording medium.

The control device 150 acquires the sensor-detected information SEN detected by the sensor 120. The sensor-detected information SEN includes surrounding situation information indicating a result of recognition by the recognition sensor. For example, the surrounding situation information includes the image captured by the camera. The surrounding situation information may include a sound detected by the microphone. The surrounding situation information may include object information regarding an object around the vehicle 100. The object information indicates a relative position and a relative speed of the object with respect to the vehicle 100.

In addition, the sensor-detected information SEN includes vehicle state information indicating the vehicle state detected by the vehicle state sensor. Further, the sensor-detected information SEN includes vehicle position information indicating the position and the orientation of the vehicle 100 obtained by the position sensor.

The control device 150 executes vehicle travel control that controls travel of the vehicle 100. The vehicle travel control includes steering control, driving control, and braking control. The control device 150 executes the vehicle travel control by controlling the travel device 130 (i.e., the steering device, the driving device, and the braking device).

The control device 150 may execute autonomous driving control based on the sensor-detected information SEN. More specifically, the control device 150 generates a travel plan of the vehicle 100 based on the sensor-detected information SEN. Further, the control device 150 generates, based on the sensor-detected information SEN, a target trajectory required for the vehicle 100 to travel in accordance with the travel plan. The target trajectory includes a target position and a target speed. Then, the control device 150 executes the vehicle travel control such that the vehicle 100 follows the target trajectory.

During the remote operation of the vehicle 100, the control device 150 communicates with the remote operator terminal 200 via the communication device 110. The control device 150 transmits the vehicle information VCL to the remote operator terminal 200. The vehicle information VCL is information necessary for the remote operation by the remote operator O, and includes at least a part of the sensor-detected information SEN described above. For example, the vehicle information VCL includes the surrounding situation information (specifically, the image). The vehicle information VCL may further include the vehicle state information and the vehicle position information. The vehicle information VCL may include the travel route and the target trajectory of the vehicle 100.

Furthermore, the control device 150 receives the remote operation information OPE from the remote operator terminal 200. The remote operation information OPE is information regarding the remote operation by the remote operator O. For example, the remote operation information OPE includes an amount of operation performed by the remote operator O. The control device 150 performs the vehicle travel control in accordance with the received remote operation information OPE.

### 4. Examples of Remote Operator Terminal

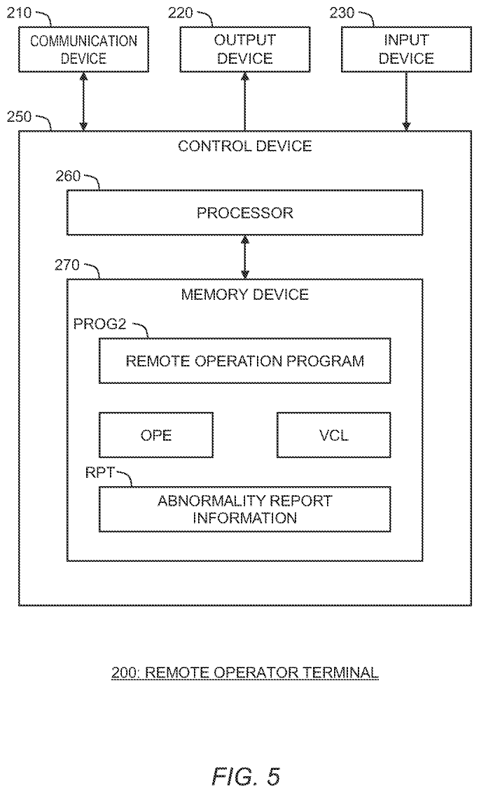

FIG. 5 is a block diagram showing a configuration example of the remote operator terminal 200. The remote operator terminal 200 includes a communication device 210, an output device 220, an input device 230, and a control device (controller) 250.

The communication device 210 communicates with the vehicle 100 and the management device 300.

The output device 220 outputs a variety of information. For example, the output device 220 includes a display device. The display device presents a variety of information to the remote operator O by displaying the variety of information. As another example, the output device 220 may include a speaker. The speaker presents audio information to the remote operator O by outputting the audio information.

The input device 230 receives an input from the remote operator O. For example, the input device 230 includes a remote operation member that is operated by the remote operator O when remotely operating the vehicle 100. The remote operation member includes a steering wheel, an accelerator pedal, a brake pedal, a direction indicator, and the like. Further, the input device 230 includes an interface (e.g., a touch panel, a keyboard, a mouse, a switch, and the like) for inputting the abnormality related to the remote operation.

The control device 250 controls the remote operator terminal 200. The control device 250 includes one or more processors 260 (hereinafter simply referred to as a processor 260) and one or more memory devices 270 (hereinafter simply referred to as a memory device 270). The processor 260 executes a variety of processing. For example, the processor 260 includes a CPU. The memory device 270 stores a variety of information necessary for the processing by the processor 260. Examples of the memory device 270 include a volatile memory, a non-volatile memory, an HDD, an SSD, and the like.

A remote operation program PROG2 is a computer program executed by the processor 260. The functions of the control device 250 are implemented by the processor 260 executing the remote operation program PROG2. The remote operation program PROG2 is stored in the memory device 270. The remote operation program PROG2 may be recorded on a non-transitory computer-readable recording medium. The remote operation program PROG2 may be provided via a network.

The control device 250 communicates with vehicle 100 via communication device 210. The control device 250 receives the vehicle information VCL transmitted from the vehicle 100. The control device 250 presents the vehicle information VCL to the remote operator O through the output device 220. For example, the control device 250 displays the image captured by the camera of the vehicle 100 on the display device. As another example, the control device 250 outputs the sound detected by the microphone of the vehicle 100 from the speaker. The remote operator O is able to recognize the state of the vehicle 100 and the situation around the vehicle 100 based on the vehicle information VCL.

The remote operator O operates the remote operation member of the input device 230. An operation amount of the remote operation member is detected by a sensor installed on the remote operation member. The control device 250 generates the remote operation information OPE reflecting the operation amount of the remote operation member operated by the remote operator O. Then, the control device 250 transmits the remote operation information OPE to the vehicle 100 via the communication device 210.

During the remote operation of the vehicle 100, the remote operator O may notice the abnormality related to the remote operation. The remote operator O uses the input device 230 to input the content of the abnormality noticed during the remote operation of the vehicle 100. The control device 250 generates the abnormality report information RPT based on the input from the remote operator O. An example of the abnormality report information RPT is as described in the above Section 2 (see FIG. 3). The control device 250 transmits the abnormality report information RPT to the management device 300 via the communication device 210.

### 5. Management Device

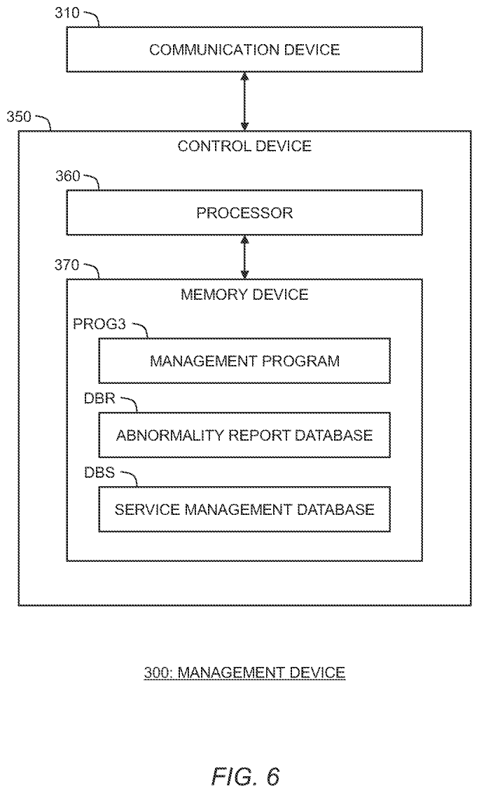

FIG. 6 is a block diagram showing a configuration example of the management device 300. The management device 300 includes a communication device 310 and a control device (controller) 350.

The communication device 310 communicates with the vehicle 100 and the remote operator terminal 200.

The control device 350 controls the management device 300. The control device 350 includes one or more processors 360 (hereinafter simply referred to as a processor 360) and one or more memory devices 370 (hereinafter simply referred to as a memory device 370). The processor 360 executes a variety of processing. For example, the processor 360 includes a CPU. The memory device 370 stores a variety of information necessary for the processing by the processor 360. Examples of the memory device 370 include a volatile memory, a non-volatile memory, an HDD, an SSD, and the like.

A management program PROG3 is a computer program executed by the processor 360. The functions of the control device 350 are implemented by the processor 360 executing the management program PROG3. The management program PROG3 is stored in the memory device 370. The management program PROG3 may be recorded on a non-transitory computer-readable recording medium. The management program PROG3 may be provided via a network.

In addition, the abnormality report database DBR and the service management database DBS are stored in the memory device 370.

The control device 350 performs the “abnormality management process” described in the above Section 2. More specifically, the control device 350 receives the abnormality report information RPT from the remote operator terminal 200 via the communication device 310. The control device 350 registers the received abnormality report information RPT on the abnormality report database DBR. Then, based on the abnormality report database DBR, the control device 350 identifies the abnormal part related to the remote operation. That is, the control device 350 determines, based on the abnormality report database DBR, whether there is an abnormality in any of the plurality of vehicle 100-1 to 100-N and whether there is an abnormality in any of the plurality of remote operator terminals 200-1 to 200-N.

The control device 350 updates the service management database DBS according to a result of the abnormality determination process described above. For example, the control device 350 excludes the vehicle 100 or the remote operator terminal 200 having the abnormality from the operation of the remote operation service. As another example, the control device 350 may suspend the operation of the remote operation service in the place where the abnormality occurs. As still another example, the control device 350 may suspend the use of the communication carrier having the abnormality.

The control device 350 may automatically arrange repair of the vehicle 100 or the remote operator terminal 200 having the abnormality.

What is claimed is:

1. A management device for managing a remote operation of a moving body,
the management device comprising one or more processors configured to:
collect abnormality report information indicating a content of an abnormality related to the remote operation of the moving body from a remote operator assigned to the moving body; and
determine, based on the abnormality report information collected from a plurality of remote operators, whether there is an abnormality in any of a plurality of moving bodies and whether there is an abnormality in any of a plurality of remote operator terminals respectively operated by the plurality of remote operators.

2. The management device according to claim 1, wherein
sensor-detected information detected by a sensor mounted on the moving body is transmitted to a remote operator terminal operated by the remote operator and is presented to the remote operator via an output device of the remote operator terminal, the remote operator remotely operates the moving body by operating a remote operation member provided in the remote operator terminal with reference to the presented sensor-detected information, and
the abnormality report information indicates at least one of:
an abnormality of the output device noticed by the remote operator;
an abnormality of the remote operation member noticed by the remote operator;
an abnormality of the sensor-detected information noticed by the remote operator; and
an abnormality of a moving body state of the moving body noticed by the remote operator.

3. The management device according to claim 2, wherein
when a number of the abnormality report information indicating the abnormality of at least one of the output device, the remote operation member, and the sensor-detected information related to a specific remote operator terminal is equal to or greater than a threshold, the one or more processors determine that there is the abnormality in the specific remote operator terminal.

4. The management device according to claim 2, wherein
when a number the abnormality report information indicating the abnormality of at least one of the sensor-detected information and the moving body state related to a specific moving body is equal to or greater than a threshold, the one or more processors determine that there is the abnormality in the specific moving body.

5. A management method for managing a remote operation of a moving body by a computer,
the management method comprising:
collecting abnormality report information indicating a content of an abnormality related to the remote operation of the moving body from a remote operator assigned to the moving body; and
determining, based on the abnormality report information collected from a plurality of remote operators, whether there is an abnormality in any of a plurality of moving bodies and whether there is an abnormality in any of a plurality of remote operator terminals respectively operated by the plurality of remote operators.
